(19) United States
(12) Patent Application Publication
(10) Pub. No.: US 2017/0160179 A1
(43) Pub. Date: Jun. 8, 2017

(54) PARTICULATE MATTER SENSOR

(71) Applicant: HYUNDAI MOTOR COMPANY, Seoul (KR)

(72) Inventors: Dong Gu KIM, Suwon-si (KR); Sang Hyeok YANG, Suwon-si (KR)

(21) Appl. No.: 15/178,215

(22) Filed: Jun. 9, 2016

(30) Foreign Application Priority Data
Dec. 8, 2015 (KR) 10-2015-0174465

(51) Int. Cl. G01N 15/06; G01M 15/10

(52) U.S. Cl. CPC G01N 15/0656; G01M 15/102; G01N 2015/0046

(57) ABSTRACT

A particulate matter (PM) sensor includes a substrate made of silicon, a temperature sensor, a heater electrode, and a measurement electrode. The temperature sensor, the heater electrode, and the measurement electrode are disposed on the substrate to be separated from each other.

### CROSS-REFERENCE TO RELATED APPLICATION

This application claims the benefit of priority to Korean Patent Application No. 10-2015-0174465 filed in the Korean Intellectual Property Office on Dec. 8, 2015, the entire content of which is incorporated herein by reference.

### TECHNICAL FIELD

The present disclosure relates to a particulate matter (PM) sensor.

### BACKGROUND

A vehicle having a diesel engine is equipped with a diesel particulate filter (DPF) which is an apparatus for processing particulate matter (PM) from an exhaust gas.

The DPF collects the PM from the exhaust gas, and applies heat to the collected PM to remove the PM. For such collection and removal of the PM, a PM sensor is used.

A typical PM sensor has multiple layers which perform a temperature control function, a heating function, and a measurement function, respectively.

The above information disclosed in this Background section is only to enhance the understanding of the background of the invention, and therefore, it may contain information that does not form the prior art that is already known in this country to a person of ordinary skill in the art.

### SUMMARY

The present disclosure has been made in an effort to simplify a structure of a particulate matter (PM) sensor.

A PM sensor according to an exemplary embodiment in the present disclosure includes a substrate made of silicon, a temperature sensor, a heater electrode, and a measurement electrode. The temperature sensor, the heater electrode, and the measurement electrode are disposed on the substrate to be separated from each other.

The temperature sensor may be disposed at an edge of the substrate to and surrounds the heater electrode.

The measurement electrode may be disposed on the temperature sensor and the heater electrode.

The PM sensor according to the exemplary embodiment of the present invention may further include further include an insulating layer disposed on each of the temperature sensor and the heater electrode.

The PM sensor according to the exemplary embodiment of the present invention includes a height member disposed on the insulating layer.

The measurement electrode may be disposed on the height member.

The substrate may include a first concave portion, a second concave portion, and a convex portion.

The first concave portion may be disposed at an edge of the substrate, and may surround the second concave portion.

The convex portion may be disposed between the first concave portion and the second concave portion.

The temperature sensor may be disposed in the first concave portion, the heater electrode may be disposed in the second concave portion, and the measurement electrode may be disposed in the convex portion.

The second concave portion may be provided in plural so that the convex portion is disposed between the second concave portions.

As described above, according to the exemplary embodiment, in the PM sensor, since the temperature sensor, the heater electrode, and measurement electrode are disposed on one substrate, a structure of the PM sensor is simplified and there is no need to apply a temperature of 800° C. or more to remove the deposited PM. Thus, the substrate can be made of silicon that is a cheaper material than that of the conventional substrate.

### BRIEF DESCRIPTION OF THE DRAWINGS

FIG. 1 schematically illustrates a particulate matter (PM) sensor according to an exemplary embodiment in the present disclosure.

FIG. 2 illustrates an example of a cross-sectional view of FIG. 1 taken along the line II-II.

FIG. 3 schematically illustrates a PM sensor according to another exemplary embodiment in the present disclosure.

FIG. 4 illustrates an example of a cross-sectional view of FIG. 2 taken along the line IV-IV.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present disclosure. On the contrary, exemplary embodiments introduced herein are provided to make disclosed contents thorough and complete and to sufficiently transfer the spirit of the present disclosure to those skilled in the art.

In the drawings, the thickness of layers, films, panels, regions, etc. are exaggerated for clarity. In the drawings, for ease of description, the thicknesses of some layers and regions are exaggerated. It will be understood that when an element such as a layer, film, region, or substrate is referred to as being “on” another element, it can be directly on the other element or intervening elements may also be present.

A particulate matter (PM) sensor according to an exemplary embodiment is in the present disclosure is provided as an exhaust gas purifying apparatus for a vehicle at a rear end of a diesel particulate filter (DPF), and measures the amount of the PM deposited on the DPF and removes the deposited PM if the measured amount of the PM exceeds a predetermined level.

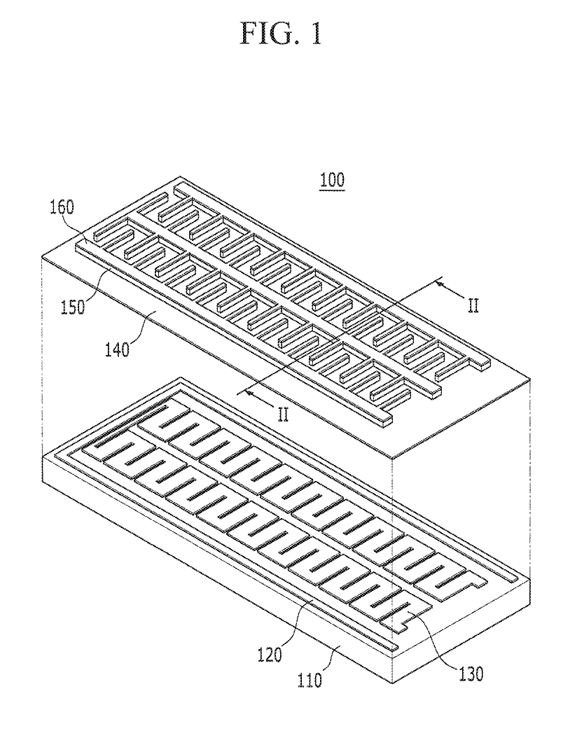

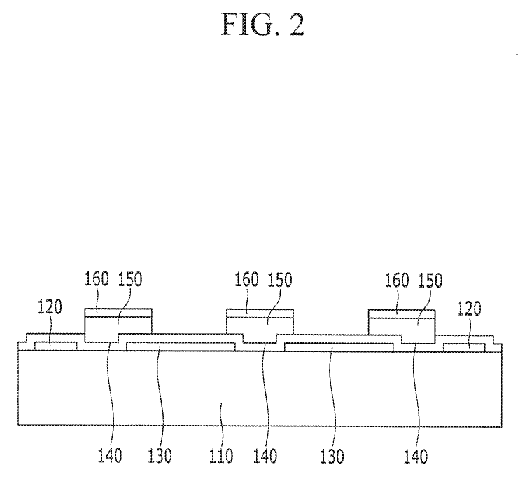

FIG. 1 schematically illustrates a PM sensor according to an exemplary embodiment in the present disclosure. FIG. 2 is an example of a cross-sectional view of FIG. 1 taken along the line II-II.

Referring to FIGS. 1 and 2, the PM sensor 100 according to the exemplary embodiment includes a substrate 110, a temperature sensor 120, a heater electrode 130, and a measurement electrode 160. An exhaust gas flows over the measurement electrode 160.

The substrate 110 may be made of silicon.

The temperature sensor 120 and the heater electrode 130 are disposed on the substrate 110 and are separated from each other. The temperature sensor 120 is disposed at an edge portion of the substrate 110, and surrounds the heater electrode 130.

An insulating layer 140 is disposed on the temperature sensor 120, the heater electrode 130, and the substrate 110, a height member 150 is disposed on the insulating layer 140, and the measurement electrode 160 is disposed on the height member 150. The height member 150 is disposed on the temperature sensor 120 and the heater electrode 130. The height member 150 is disposed in a portion between the temperature sensor 120 and the heat electrode 130, and a portion corresponding to the heat electrode 130. That is, the height member 150 overlaps the heat electrode 130. Thus, the 1.5 measurement electrode 160 disposed on the height member 150 also overlaps the heater electrode 130. However, the exemplary embodiment is not limited thereto, in which the height member 150 and the measurement electrode 160 may not overlap the heater electrode 130.

The measurement electrode 160 includes a plurality of electrodes that are separated from each other, and each electrode has a comb-like shape that has a plurality of branch electrodes. The branch electrodes of one electrode are alternately disposed with respect to the branch electrodes of another electrode. Herein, the height member 150 serves to secure a space in which the PM can be deposited between the plurality of electrodes.

When the exhaust gas flows over the measurement electrode 160, the PM is deposited on the measurement electrode 160. In this case, the PM is deposited between the measurement electrode 160 and the plurality of electrodes that form the measurement electrode 160. Resistance or capacitance between the plurality of electrodes varies depending on an amount of the deposited PM. The amount of the PM is measured by measuring a variation in the resistance or the capacitance between the plurality of electrodes.

When the measured amount of the PM exceeds a predetermined level, heat is applied using the heater electrode 130 to the deposited PM, thereby removing the deposited PM. Generally, a temperature for removal of the deposited PM, which is controlled by the temperature sensor 120, is about 650° C.

In the related art, a PM sensor has a structure in which a substrate where a heater electrode is disposed, a substrate where a temperature sensor is disposed, and a substrate where a measurement electrode is disposed are sequentially stacked. Due to such a structure, two substrates are disposed between the heater electrode and the measurement electrode. Thus, in order to remove the deposited PM, a temperature of about 800° C. or more should be applied, which is generally higher than the temperature of about 650° C. for the removal of the deposited PM. Accordingly, the substrate that can withstand the high temperature of 800° C. or more should also be used.

However, in the PM sensor 100 according to the current exemplary embodiment, since the temperature sensor 120, the heater electrode 130, and the measurement electrode 160 are disposed on one substrate 110, there is no need to apply the temperature of about 800° C. or more to remove the deposited PM. Accordingly, the substrate 110 may be made of silicon that is a cheaper material than that of the conventional substrate,

In addition, since the temperature sensor 120, the heater electrode 130, and the measurement electrode 160 are disposed on one substrate 110, a structure of the PM sensor 100 may be simplified.

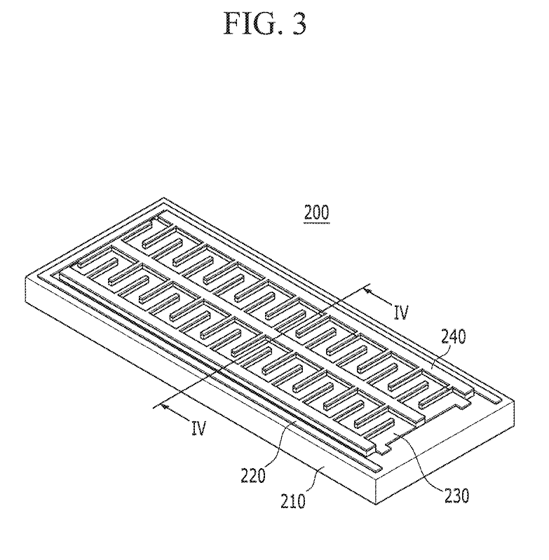

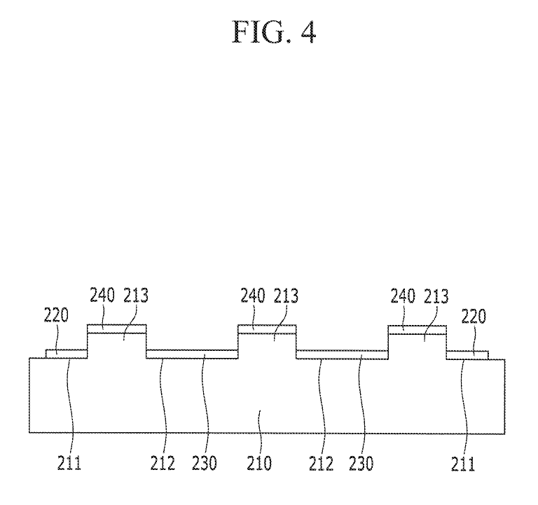

A PM sensor according to another exemplary embodiment in the present disclosure will now be described with reference to FIGS. 3 and 4.

FIG. 3 schematically illustrates a PM sensor according to another exemplary embodiment in the present disclosure. FIG. 4 illustrates an example of a cross-sectional view of FIG. 2 taken along the line IV-IV.

Referring to FIGS. 3 and 4, the PM sensor 200 according to the exemplary embodiment includes a substrate 210, and a temperature sensor 220, a heater electrode 230, and a measurement electrode 240 that are disposed on the substrate 210.

The substrate 210 is made of silicon, and includes a first concave portion 211, a second concave portion 212, and a convex portion 213. The first concave portion 211 is disposed to surround an edge of the substrate 210, and the second concave portion 212 is disposed between the first concave portions 211. That is, the first concave portion 211 surrounds the second concave portion 212, The convex portion 213 is disposed between the first concave portion 211 and the second concave portion 212. In addition, the convex portion 213 is also disposed between the second concave portions 212.

The temperature sensor 220 is disposed in the first concave portion 211, and the heater electrode 230 is disposed in the second concave portion 212. In addition, the measurement electrode 240 is disposed in the convex portion 213. The temperature sensor 220, the heater electrode 230, and the measurement electrode 240 are separated from each other by the convex portion 213.

Structures and functions of the temperature sensor 220, the heater electrode 230, and the measurement electrode 240 are the same as those of the temperature sensor, the heater electrode and the measurement electrode of the PM sensor according to FIG. 2. Thus, a description of the temperature sensor 220, the heater electrode 230, and the measurement electrode 240 will be omitted.

As described above, in the PM sensor 200 according to the exemplary embodiment, since the temperature sensor 220, the heater electrode 230, and the measurement electrode 240 are disposed on one substrate 210, a structure of the PM sensor 200 is simplified and there is no need to apply heat of about 800° C. or more to remove deposited PM, the substrate 210 may be made of silicon that is cheaper material than that the conventional substrate.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A particulate matter (PM) sensor comprising:
a substrate made of silicon;
a temperature sensor;
a heater electrode; and
a measurement electrode,
wherein the temperature sensor, the heater electrode, and the measurement electrode are disposed on the substrate and separated from each other,

2. The PM sensor of claim 1, wherein the temperature sensor is disposed at an edge of the substrate and surrounds the heater electrode.

3. The PM sensor of claim 2, wherein the measurement electrode is disposed on the temperature sensor and the heater electrode.

4. The PM sensor of claim 3, further comprising an insulating layer disposed on each of the temperature sensor and the heater electrode.

5. The PM sensor of claim 4, further comprising a height member disposed on the insulating layer.

6. The PM sensor of claim 5, wherein the measurement electrode is disposed on the height member.

7. The PM sensor of claim 3, wherein the substrate includes a first concave portion, a second concave portion, and a convex portion.

8. The PM sensor of claim 7, wherein the first concave portion is disposed at an edge of the substrate and surrounds the second concave portion.

9. The PM sensor of claim 8, wherein the convex portion is disposed between the first concave portion and the second concave portion.

10. The PM sensor of claim 9, wherein the temperature sensor is disposed in the first concave portion, the heater electrode is disposed in the second concave portion, and the measurement electrode is disposed in the convex portion.

11. The PM sensor of claim 8, wherein the second concave portion is provided in plural so that the convex portion is disposed between the second concave portions.
